(19) United States
(12) Patent Application Publication
(10) Pub. No.: US 2022/0368861 A1
(43) Pub. Date: Nov. 17, 2022

(54) VIDEO COMMUNICATION METHOD, VIDEO COMMUNICATION SYSTEM, AND RECEIVING-SIDE DEVICE

(71) Applicant: WOVEN PLANET HOLDINGS, INC., Tokyo (JP)

(72) Inventor: Toshinobu WATANABE, Tokyo-to (JP)

(73) Assignee: WOVEN PLANET HOLDINGS, INC., Tokyo (JP)

(21) Appl. No.: 17/725,702

(22) Filed: Apr. 21, 2022

(30) Foreign Application Priority Data
May 10, 2021 (JP) 2021-079667

(51) Int. Cl. H04N 7/18; H04L 47/12; H04N 5/92; H04N 5/77

(52) U.S. Cl. CPC H04N 7/183; H04L 47/12; H04N 5/92; H04N 5/77

(57) ABSTRACT

A video is transmitted from a transmitting-side to a receiving-side by a preference transmission method that is any of a first transmission method and a second transmission method. The first transmission method transmits an original video as the video. The second transmission method generates a reduced video by reducing the original video and transmits the reduced video as the video. When receiving the reduced video, the receiving-side applies a super-resolution technique to the reduced video to improve the image quality. A first delay time is a transmission time by the first transmission method. A second delay time is a sum of a transmission time by the second transmission method and the super-resolution processing time. A transmission method corresponding to a shorter one of the first delay time and the second delay time is selected as the preference transmission method.

### CROSS-REFERENCE TO RELATED APPLICATION

This application claims priority to Japanese Patent Application No. 2021-079667 filed on May 10, 2021, the entire contents of which are incorporated by reference herein.

### BACKGROUND

### Technical Field

The present disclosure relates to a technique of video transmission.

### Background Art

When congestion occurs in communication, a “congestion control” for controlling a communication traffic may be performed (see Patent Literature 1). The congestion control makes it possible to suppress a communication delay and to avoid a communication disruption. For example, when a communication rate decreases during communication of a video, the transmitting side may perform the congestion control that reduces an image size of the video.

Non-Patent Literature 1 discloses a “super-resolution technique” that converts an input low-resolution image into a high-resolution image. In particular, Non-Patent Literature 1 discloses an SRCNN that applies deep learning based on a convolutional neural network (CNN) to the super-resolution (SR). A model for converting (mapping) the input low resolution image into the high resolution image is obtained through the machine learning.

### LIST OF RELATED ART

Patent Literature 1: Japanese Laid-Open Patent Application Publication No. JP-2019-009709

Non Patent Literature 1: Chao Dong, Chen Change Loy, Kaiming He, and Xiaoou Tang, “Image Super-Resolution Using Deep Convolutional Networks”, arXiv: 1501.00092v3 [cs.CV], Jul. 31, 2015 (https://arxiv.org/pdf/1501.00092.pdf)

### SUMMARY

Video transmission via a communication network is considered. From a standpoint of use of the video on the receiving side, it is preferable that an image quality of the video is high and a communication delay is low. That is, it is preferable to satisfy both high image quality and low delay. However, when a communication rate decreases and thus a congestion control is performed on the transmission-side, the image quality of the video transmitted to the receiving side deteriorates.

An object of the present disclosure is to provide a technique that can satisfy both high image quality and low delay in video transmission.

A first aspect is directed to a video communication method of transmitting a video from a transmitting-side device to a receiving-side device.

The video communication method includes a transmission process that transmits the video by a preference transmission method that is any of a first transmission method and a second transmission method.

The first transmission method transmits an original video as the video.

The second transmission method generates a reduced video by reducing the original video and transmits the reduced video as the video.

The video communication method further includes:

a reception process that receives the video transmitted; and

a super-resolution process that, when the reduced video transmitted by the second transmission method is received, applies a super-resolution technique to the reduced video to generate an improved video.

A transmission time is a time required for transmission of the video from the transmitting-side device to the receiving-side device.

A first delay time is the transmission time in a case of the first transmission method.

A second delay time is a sum of the transmission time in a case of the second transmission method and a super-resolution processing time required for generating the improved video by the super-resolution technique.

The video communication method further includes a selection process that compares the first delay time and the second delay time to select a transmission method corresponding to a shorter one of the first delay time and the second delay time as the preference transmission method.

A second aspect is directed to a video communication system.

The video communication system includes:

a transmitting-side device configured to transmit a video by a preference transmission method that is any of a first transmission method and a second transmission method; and

a receiving-side device configured to receive the video transmitted from the transmitting-side device.

The first transmission method transmits an original video as the video.

The second transmission method generates a reduced video by reducing the original video and transmits the reduced video as the video.

The receiving-side device is further configured to, when receiving the reduced video transmitted by the second transmission method, apply a super-resolution technique to the reduced video to generate an improved video.

A transmission time is a time required for transmission of the video from the transmitting-side device to the receiving-side device.

A first delay time is the transmission time in a case of the first transmission method.

A second delay time is a sum of the transmission time in a case of the second transmission method and a super-resolution processing time required for generating the improved video by the super-resolution technique.

The receiving-side device further compares the first delay time and the second delay time to select a transmission method corresponding to a shorter one of the first delay time and the second delay time as the preference transmission method. Then, the receiving-side device notifies the transmitting-side device of the preference transmission method.

A third aspect is directed to a receiving-side device that receives a video transmitted from a transmitting-side device.

The transmitting-side device transmits the video by a preference transmission method that is any of a first transmission method and a second transmission method.

The first transmission method transmits an original video as the video.

The second transmission method generates a reduced video by reducing the original video and transmits the reduced video as the video.

The receiving-side device has one or more processors.

The ore or more processors are configured to:

receive the video transmitted from the transmitting-side device; and

when receiving the reduced video transmitted by the second transmission method, apply a super-resolution technique to the reduced video to generate an improved video.

A transmission time is a time required for transmission of the video from the transmitting-side device to the receiving-side device.

A first delay time is the transmission time in a case of the first transmission method.

A second delay time is a sum of the transmission time in a case of the second transmission method and a super-resolution processing time required for generating the improved video by the super-resolution technique.

The one or more processors further compare the first delay time and the second delay time to select a transmission method corresponding to a shorter one of the first delay time and the second delay time as the preference transmission method. Then, the one or more processors notify the transmitting-side device of the preference transmission method.

According to the present disclosure, one with a shorter delay time among the first transmission method and the second transmission method is selected as the preference transmission method. It is therefore possible to lower the delay of the video transmission. Moreover, when the preference transmission method is the first transmission method, the original video is transmitted from the transmitting-side device to the receiving-side device, and thus deterioration in the image quality is not caused. Even when the preference transmission method is the second transmission method, the super-resolution technique is applied to the reduced video in the receiving-side device, and thus the image quality is improved. It is therefore possible to satisfy both the high image quality and the low delay.

### BRIEF DESCRIPTION OF DRAWINGS

FIG. 1 is a block diagram showing an outline of a video communication system according to an embodiment of the present disclosure;

FIG. 2 is a conceptual diagram showing a remote support system that is an application example of a video communication system according to an embodiment of the present disclosure;

FIG. 3 is a block diagram for explaining a congestion control and a super-resolution process in a video communication system according to an embodiment of the present disclosure;

FIG. 4 is a conceptual diagram for explaining a method of determining a transmission method in an embodiment of the present disclosure;

FIG. 5 is a conceptual diagram for explaining a delay time estimation process according to an embodiment of the present disclosure;

FIG. 6 is a block diagram showing a functional configuration example related to a video communication process according to an embodiment of the present disclosure;

FIG. 7 is a flow chart showing processing related to transmission method switching according to an embodiment of the present disclosure;

FIG. 8 is a flow chart showing a modification example of processing related to transmission method switching according to an embodiment of the present disclosure;

FIG. 9 is a block diagram showing a configuration example of a moving body according to an embodiment of the present disclosure; and

FIG. 10 is a block diagram showing a configuration example of a remote support device according to an embodiment of the present disclosure.

### EMBODIMENTS

Embodiments of the present disclosure will be described with reference to the accompanying drawings.

### 1. VIDEO COMMUNICATION SYSTEM

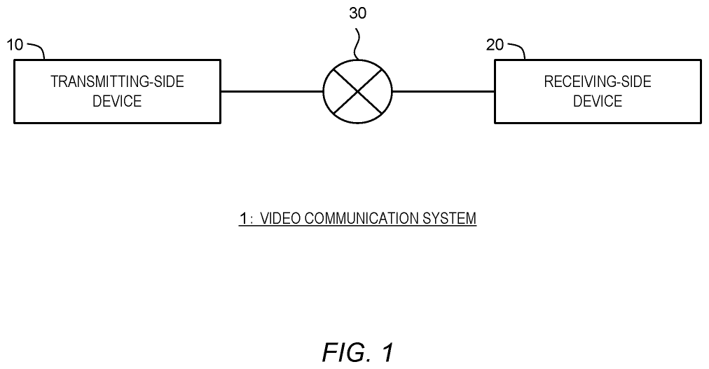

FIG. 1 is a conceptual diagram showing an outline of a video communication system 1 according to the present embodiment. The video communication system 1 includes a transmitting-side device 10, a receiving-side device 20, and a communication network 30. The transmitting-side device 10 and the receiving-side device 20 are connected to each other via the communication network 30. The transmitting-side device 10 and the receiving-side device 20 is able to communicate with each other via the communication network 30. For example, the transmitting side device 10 and the receiving-side device 20 performs wireless communication. However, the present embodiment is not limited to wireless communication.

The transmitting-side device 10 is installed, for example, on a moving body. Examples of the moving body include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

The receiving-side device 20 is installed, for example, on an external device that communicates with the moving body. For example, the external device is a management server for managing the moving body. As another example, the external device may be a remote support device that remotely supports an operation of the moving body. As yet another example, the external device may be another moving body different from the moving body on which the transmitting-side device 10 is installed.

The transmitting-side device 10 acquires a video and transmits the video to the receiving-side device 20. The video is transmitted to the receiving-side device 20 via the communication network 30. The receiving-side device 20 receives the video and outputs the received video.

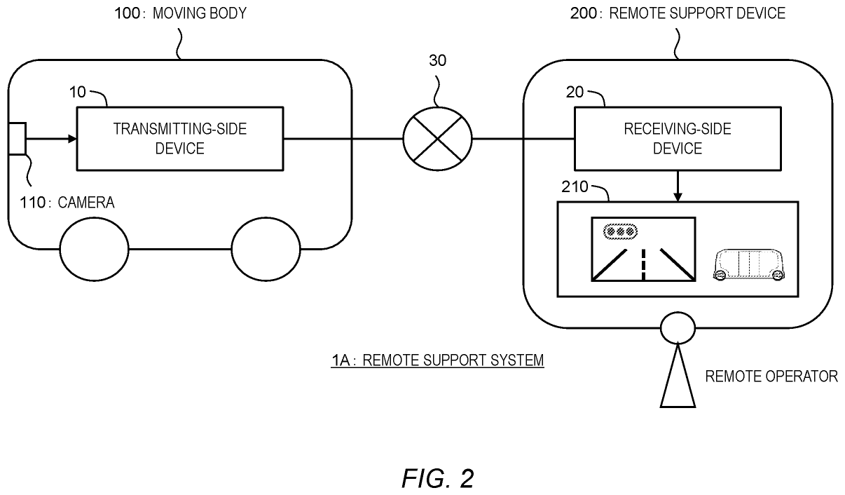

FIG. 2 shows a remote support system 1A which is an application example of the video communication system 1. The transmitting-side device 10 is installed on a moving body 100, and the receiving-side device 20 is installed on a remote support device 200. The remote support device 200 remotely supports an operation of the moving body 100 based on the video transmitted from the moving body 100.

More specifically, a camera 110 is installed on the moving body 100. The camera 110 images a situation around the moving body 100 to acquire a video showing the situation. The transmitting-side device 10 transmits the video acquired by the camera 110 to the remote support device 200. The receiving-side device 20 of the remote support device 200 receives the video transmitted from the transmitting-side device 10 of the moving body 100. The remote support device 200 displays the received video on a display device 210. An operator looks at the video displayed on the display device 210 to grasp the situation around the moving body 100 and remotely support the operation of the moving body 100. Examples of the remote support by the operator include recognition support, judgement support, remote driving, and the like. An instruction from the operator is transmitted from the receiving-side device 20 to the transmitting-side device 10 of the moving body 100. The moving body 100 operates according to the instruction from the operator.

From a standpoint of use of the video on the receiving side, it is preferable that an image quality of the video is high and a communication delay is low. That is, it is preferable to satisfy both high image quality and low delay. For example, in the scene of remote support described above, the image quality of the video is important for the operator to grasp the situation around the moving body 100 as accurately as possible. Moreover, the low delay is important in the remote support in which realtimeness is required. That is to say, to satisfy both the high image quality and the low delay is desirable in terms of remote support accuracy.

The present disclosure provides a technique that can satisfy both the high image quality and the low delay in the video transmission.

### 2. CONGESTION CONTROL AND SUPER-RESOLUTION TECHNIQUE

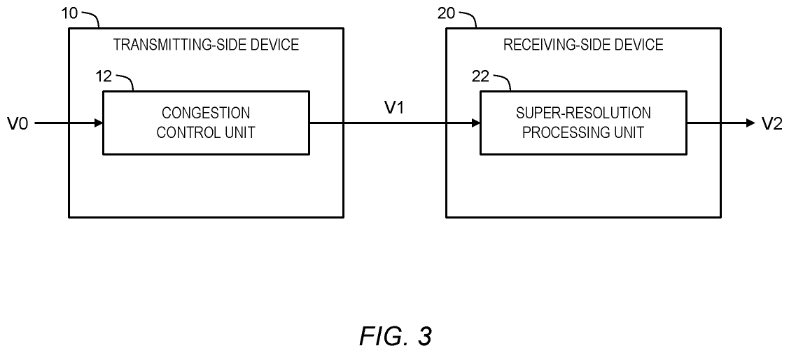

FIG. 3 is a block diagram for explaining a congestion control and a super-resolution process in the video communication system 1 according to the present embodiment.

The transmitting side device 10 includes a congestion control unit 12. During the video transmission, the congestion control unit 12 performs a congestion control that reduces an image size (number of pixels) of the video, if necessary. For example, when a communication rate (throughput) of a communication line decreases to a certain level or less, the congestion control unit 12 performs the congestion control with respect to the video. For convenience sake, the video before the congestion control is performed is referred to as an “original video V0”, and the video generated by reducing the original video V0 is referred to as a “reduced video V1.” The congestion control unit 12 generates the reduced video V1 by performing the congestion control with respect to the original video V0.

When such the congestion control is performed, the transmitting side device 10 transmits the reduced video V1 instead of the original video V0 to the receiving-side device 20. Since a data transmission amount is reduced, it is possible to suppress a communication delay and to avoid a communication disruption. However, the image quality of the reduced video V1 is lower than the image quality of the original video V0. This is not preferable from the standpoint of use of the video. In view of the above, in the present embodiment, a “super-resolution technique” is utilized for improving the image quality of the video in the receiving-side device 20.

The receiving-side device 20 includes a super-resolution processing unit 22. The super-resolution processing unit 22 determines whether the received video is the original video V0 or the reduced video V1 based on the image size (i.e., the number of pixels) of the received video. In other words, the super-resolution processing unit 22 determines whether or not the congestion control is performed in the transmitting side device 10. When it is determined that the congestion control is being performed, the super-resolution processing unit 22 applies the super-resolution technique to the reduced video V1 to improve the image quality. The super-resolution technique can convert the low-resolution image to be input into a high-resolution image. Various techniques of the super-resolution technique has been proposed (e.g., see Non-Patent Document 1). In the present embodiment, the method of the super-resolution technique is not particularly limited.

The video whose image quality is improved by the super-resolution technique is hereinafter referred to as an “improved video V2”, for convenience sake. The super-resolution processing unit 22 generates the improved video V2 by applying the super-resolution technique to the reduced video V1. Since the improved video V2 with a higher image quality than the reduced video V1 is obtained, a user is able to see the video more clearly. For example, in the scene of remote support described above, it becomes easier for the operator to accurately grasp the situation around the moving body 100. As a result, the remote support accuracy is improved.

As described above, combining the congestion control and the super-resolution technique makes it possible to satisfy both the high image quality and the low delay in the video transmission.

### 3. SWITCHING OF VIDEO TRANSMISSION METHOD

### 3-1. Outline

When the congestion control is performed in the transmitting-side device 10, a data transmission amount is reduced, and thus a data transmission time on the communication network 30 is shortened. Meanwhile, a certain amount of time is required for the super-resolution process for improving the image quality in the receiving-side device 20. In order to more accurately estimate a total delay time from sending out of the video to utilization of the video, it is preferable to take the time required for the super-resolution process into account as well. In some situations, not performing the congestion control in the transmitting-side device 10 may result in a shorter total delay time.

In view of the above, the present disclosure further provides a technique that can switch a video transmission method according to a situation.

The transmitting-side device 10 according to the present embodiment is able to transmit the video by two types of transmission methods, a first transmission method and a second transmission method. The first transmission method transmits the original video V0 without performing the congestion control. On the other hand, the second transmission method generates the reduced video V1 by performing the congestion control to reduce the original video VO, and transmits the reduced video V1. The transmitting-side device 10 transmits the video to the receiving-side device 20 by any one of the first transmission method and the second transmission method. The one of the first transmission method and the second transmission method used for transmitting the video is hereinafter referred to as a “preference transmission method.”

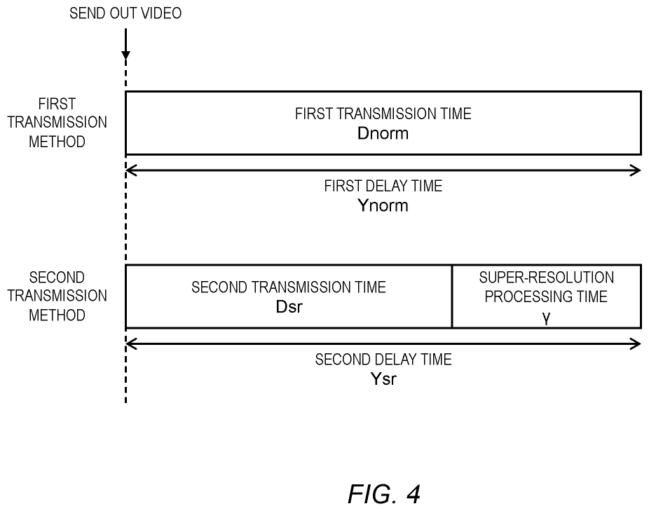

FIG. 4 is a conceptual diagram for explaining a method of determining the preference transmission method. A “transmission time” is a time required for transmission of the video from the transmitting-side device 10 to the receiving-side device 20 via the communication network 30. The transmission time depends on a data amount of the video to be transmitted and a bit rate of a communication line between the transmitting-side device 10 and the receiving-side device 20. A “first transmission time Dnorm” is the transmission time in the case of the first transmission method. That is, the first transmission time Dnorm is a time required for transmission of the original video V0 from the transmitting-side device 10 to the receiving-side device 20. On the other hand, a “second transmission time Dsr” is the transmission time in the case of the second transmission method. That is, the second transmission time Dsr is a time required for transmission of the reduced video V1 from the transmitting-side device 10 to the receiving-side device 20.

A “first delay time Ynorm” is a delay time in the case of the first transmission method. The first delay time Ynorm is equal to the first transmission time Dnorm described above (i.e., Ynorm=Dnorm). On the other hand, a “second delay time Ysr” is a delay time in the case of the second transmission method. The second delay time Ysr is defined as a sum of the above-described second transmission time Dsr a the super-resolution processing time γ (i.e., Ysr=Dsr+γ). The super-resolution processing time γ is a processing time required for generating the improved video V2 by applying the super-resolution technique to the reduced video V1. A specific example of a method of estimating the first delay time Ynorm and the second delay time Ysr will be described later.

According to the present embodiment, a comparison is made between the first delay time Ynorm and the second delay time Ysr. Then, a transmission method corresponding to a shorter one of the first delay time Ynorm and the second delay time Ysr is selected as the preference transmission method. That is, when the first delay time Ynorm is equal to or less than the second delay time Ysr, the first transmission method is selected as the preference transmission method. On the other hand, when the second delay time Ysr is less than the first delay time Ynorm, the second transmission method is selected as the preference transmission method. The transmitting-side device 10 transmits the video by the preference (selected) transmission method.

As described above, one with a shorter delay time among the first transmission method and the second transmission method is selected as the preference transmission method. It is therefore possible to further lower the delay of the video transmission. Moreover, when the preference transmission method is the first transmission method, the original video V0 is transmitted from the transmitting-side device 10 to the receiving-side device 20, and thus deterioration in the image quality is not caused. Even when the preference transmission method is the second transmission method, the super-resolution technique is applied to the reduced video V1 in the receiving-side device 20, and thus the image quality is improved. It is therefore possible to satisfy both the high image quality and the low delay. For example, satisfying both the high image quality and the low delay contributes to an improvement in the remote support accuracy.

### 3-2. Delay Time Estimation Process

Hereinafter, a specific example of a method of estimating the first delay time Ynorm and the second delay time Ysr will be described.

The first delay time Ynorm in the case of the first transmission method is expressed by the following Equation (1).

$$[ Equation 1 ]$$

$$Ynorm = Dnorm = \frac{X}{α} + β \qquad ( 1 )$$

Here, α [bps] is a bit rate of a communication line between the transmitting-side device 10 and the receiving-side device 20. X [bit] is the data amount of the original video V0. X/α [sec] is a variable delay (a first variable delay) in the communication line (first variable delay) and depends on the data amount X of the original video V0 and the bit rate α. β [sec] is a fixed delay in the communication line and does not depend on the transmission method. The first transmission time Dnorm in the case of the first transmission method is expressed by a sum of the first variable delay X/α and the fixed delay β.

On the other hand, the second delay time Ysr in the case of the second transmission method is expressed by the following Equation (2).

$$[ Equation 2 ]$$

$$Ysr = Dsr + γ = \frac{X}{α K} + β + γ \qquad ( 2 )$$

Here, X/K [bit] is the data amount of the reduced video V1. 1/K is a reduction ratio of the image size in the congestion control. It is also possible to say that the parameter K is a magnification factor of the image size in the super-resolution process. The parameter K is a fixed value. X/(αK) [sec] is a variable delay (a second variable delay) in the communication line and depends on the data amount X/K of the reduced video V1 and the bit rate α. The second transmission time Dsr in the case of the second transmission method is expressed by a sum of the second variable delay X/(αK) and the fixed delay β. As described above, the super-resolution processing time γ is a processing time required for generating the improved video V2 by applying the super-resolution technique to the reduced video V1. A fixed value is also used as the super-resolution processing time γ.

The receiving-side device 20 can calculate the data amount (X or X/K) and the transmission time (Dnorm or Dsr) of the transmitted video based on information included in the received video. More specifically, a data amount of the video received by the receiving-side device 20, as it is, is regarded as the data amount of the video transmitted from the transmitting-side device 10. Moreover, a transmission timing is recorded as a time stamp in each frame of the video. The receiving-side device 20 is able to calculate the transmission time by taking a difference between a reception timing and the transmission timing.

The receiving-side device 20 accumulates data of a combination of the data amount (X or X/K) and the transmission time (Dnorm or Dsr) of the video. Then, the receiving-side device 20 estimates the bit rate a and the fixed delay β based on records of the correspondence relationship between the data amount and the transmission time of the video in a certain period of time.

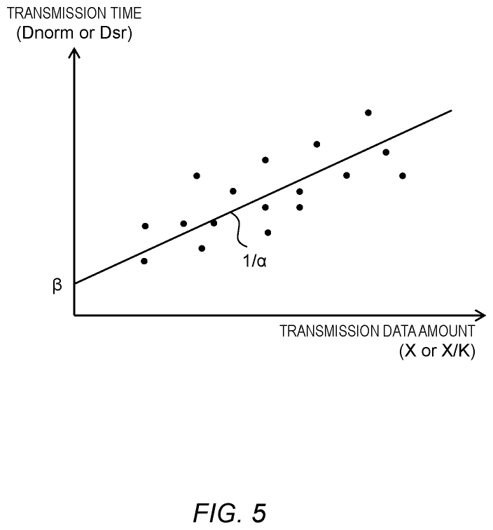

FIG. 5 shows an example of a distribution of the data amount (X or X/K) and the transmission time (Dnorm or Dsr) of the video in a certain period of time. A horizontal axis represents the data amount, and a vertical axis represents the transmission time. As can be seen from the above Equations (1) and (2), a slope of a regression line with respect to the distribution corresponds to 1/α, and an y-intercept of the regression line corresponds to the fixed delay β. Therefore, the receiving-side device 20 is able to estimate the bit rate α and the fixed delay β by calculating the regression line with respect to the distribution of the data amount and the transmission time of the video in a certain period of time. However, the method of estimating the bit rate α and the fixed delay β is not limited to this example. For example, optimization using a more precise model is also possible.

In this manner, the bit rate α and the fixed delay β are estimated. The parameter K and the super-resolution processing time γ are fixed values. Therefore, using the above Equations (1) and (2) makes it possible to calculate (estimate) both the first delay time Ynorm and the second delay time Ysr for the same data amount X. That is, the receiving-side device 20 estimates the bit rate α and the fixed delay β based on the records of the video transmission, and further calculates (estimates) both the first delay time Ynorm and the second delay time Ysr based on the bit rate α, the fixed delay β, and the super-resolution processing time γ.

### 3-3. Functional Configuration Example

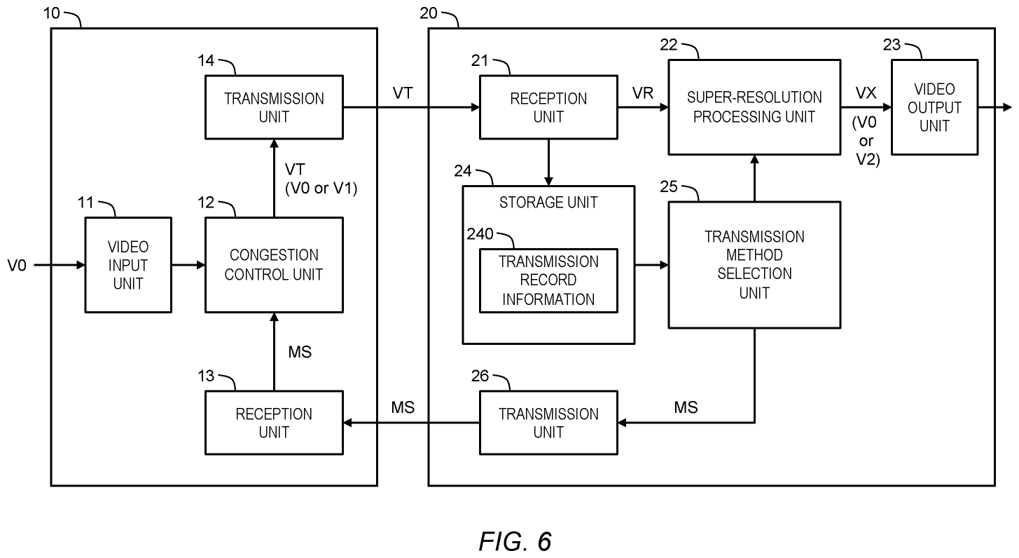

FIG. 6 is a block diagram showing a functional configuration example related to the video communication process according to the present embodiment.

The transmitting-side device 10 includes a video input unit 11, the congestion control unit 12, a reception unit 13, and a transmission unit 14.

The video input unit 11 receives the original video V0 and outputs the original video V0 to the congestion control unit 12.

The congestion control unit 12 performs the congestion control with respect to the original video V0, if necessary. More specifically, the congestion control unit 12 receives preference transmission method information MS from the receiving-side device 20 via the reception unit 13. The preference transmission method information MS is information specifying the preference transmission method. When the preference transmission method is the first transmission method, the congestion control unit 12 sets the original video V0 as it is as a transmission video VT without performing the congestion control. On the other hand, when the preference transmission method is the second transmission method, the congestion control unit 12 generates the reduced video V1 by reducing the original video V0, and sets the reduced video V1 as the transmission video VT.

The transmission unit 14 transmits the transmission video VT (i.e., the original video V0 or the reduced video V1) to the receiving-side device 20.

The receiving-side device 20 includes a reception unit 21, the super-resolution processing unit 22, a video output unit 23, a storage unit 24, a transmission method selection unit 25, and a transmission unit 26.

The reception unit 21 receives the transmission video VT transmitted from the transmitting-side device 10. The received video is hereinafter referred to as a received video VR. The reception unit 21 outputs the received video VR to the super-resolution processing unit 22.

The super-resolution processing unit 22 performs the super-resolution process with respect to the received video VR, if necessary. More specifically, the super-resolution processing unit 22 determines whether the received video VR is the original video V0 or the reduced video V1 based on the image size (i.e., the number of pixels) of the received video VR. In other words, the super-resolution processing unit 22 determines whether or not the congestion control is performed in the transmitting-side device 10. When the congestion control is not performed, the super-resolution processing unit 22 sets the received video VR (i.e., the original video V0) as it is as an output video VX. On the other hand, when it is determined that the congestion control is being performed, the super-resolution processing unit 22 generates the improved video V2 by applying the super-resolution technique to the reduced video V1, and sets the improved video V2 as the output video VX.

The video output unit 23 outputs the output video VX (i.e., the original video V0 or the improved video V2). For example, the video output unit 23 displays the output video VX on the display device 210 (see FIG. 2).

Moreover, the reception unit 21 calculates the data amount (X or X/K) and the transmission time (Dnorm or Dsr) of the transmission video VT, based on information included in the received video VR. The reception unit 21 notifies the storage unit 24 of information of the combination of the calculated data amount and the calculated transmission time.

The storage unit 24 accumulates (stores) the information notified from the reception unit 21 as transmission record information 240. That is, the transmission record information 240 indicates records of the correspondence relationship between the data amount (X or X/K) and the transmission time (Dnorm or Dsr) of the video.

The transmission method selection unit 25 selects any of the first transmission method and the second transmission method as the preference transmission method. More specifically, the transmission method selection unit 25 estimates the bit rate α and the fixed delay β based on the transmission record information 240 accumulated in a certain period of time. Further, the transmission method selection unit 25 calculates both the first delay time Ynorm and the second delay time Ysr based on the bit-rate α, the fixed delay β, and the super-resolution processing time γ (see the above Equations (1) and (2)).

Then, the transmission method selection unit 25 compares the first delay time Ynorm and the second delay time Ysr to select a transmission method corresponding to a shorter one of the first delay time Ynorm and the second delay time Ysr as the preference transmission method. When the first delay time Ynorm is equal to or less than the second delay time Ysr, the transmission method selection unit 25 selects the first transmission method as the preference transmission method. On the other hand, when the second delay time Ysr is less than the first delay time Ynorm, the transmission method selection unit 25 selects the second transmission method as the preference transmission method. The transmission method selection unit 25 outputs the preference transmission method information MS that specifies the preference (selected) transmission method to the transmission unit 26.

The transmission unit 26 transmits the preference transmission method information MS to the transmitting-side device 10. In other words, the transmission unit 26 notifies the transmitting-side device 10 of the preference transmission method.

The reception unit 13 of the transmitting-side device 10 receives the preference transmission method information MS from the receiving-side device 20 and outputs the preference transmission method information MS to the congestion control unit 12. The congestion control unit 12 performs or does not perform the congestion control in accordance with the preference transmission method specified by the preference transmission method information MS.

It should be noted that when switching of the preference transmission method occurs, the transmission method selecting unit 25 may beforehand notify the super-resolution processing unit 22 of the occurrence of switching of the preference transmission method. In this case, the super-resolution processing unit 22 can determine whether or not to perform the super-resolution process by referring to the prior notification.

### 3-4. Process Flow

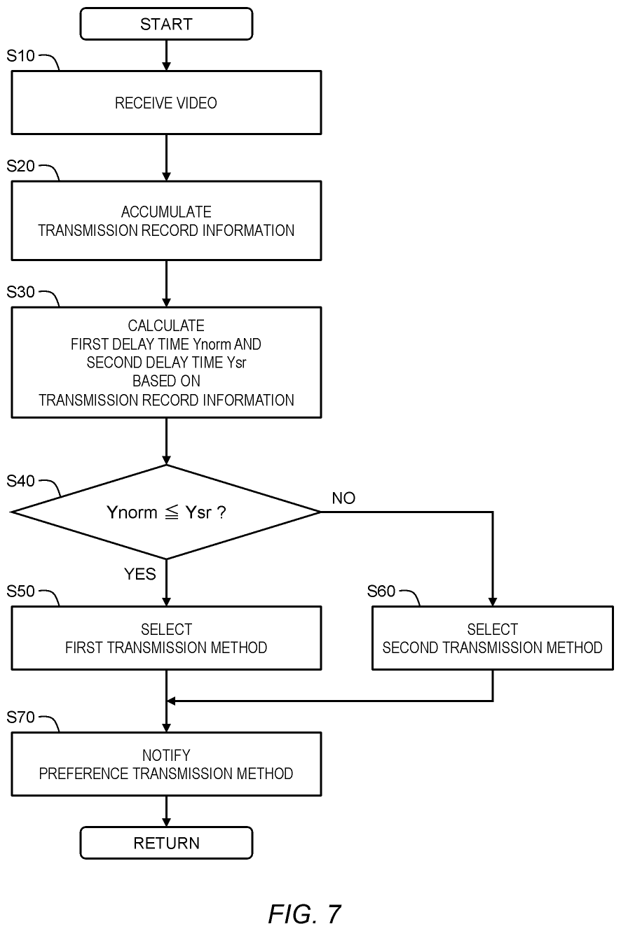

FIG. 7 is a flow chart showing processing related to transmission method switching according to the present embodiment.

In Step S10, the transmitting-side device 10 transmits the video by the preference transmission method that is any one of the first transmission method and the second transmission method (“transmission process”). The receiving-side device 20 receives the video transmitted from the transmitting-side device 10 (“reception process”).

In Step S20, the receiving-side device 20 calculates the data amount (X or X/K) and the transmission time (Dnorm or Dsr) of the video based on information included in the received video VR. The receiving-side device 20 accumulates (stores) the transmission record information 240 indicating the record of the correspondence relationship between the data amount and the transmission time of the video.

In Step S30, the receiving-side device 20 calculates (estimates) the first delay time Ynorm and the second delay time Ysr based on the transmission record information 240 in a certain period of time.

In Step S40, the receiving-side device 20 compares the first delay time Ynorm and the second delay time Ysr.

When the first delay time Ynorm is equal to or less than the second delay time Ysr (Step S40; Yes), the receiving-side device 20 selects the first transmission method as the preference transmission method (Step S50).

On the other hand, when the second delay time Ysr is less than the first delay time Ynorm (Step S40; No), the receiving-side device 20 selects the second transmission method as the preference transmission method (Step S60).

The above-described Steps S20 to S60 correspond to a “selection process” that selects the preference transmission method according to a situation.

In Step S70, the receiving-side device 20 performs a “notification process” that notifies the transmitting-side device 10 of the preference transmission method. The transmitting-side device 10 performs the transmission process in accordance with the preference transmission method notified from the receiving-side device 20.

### 3-5. Effects

As described above, according to the present embodiment, one with a shorter delay time among the first transmission method and the second transmission method is selected as the preference transmission method. It is therefore possible to further lower the delay of the video transmission. Moreover, when the preference transmission method is the first transmission method, the original video V0 is transmitted from the transmitting-side device 10 to the receiving-side device 20, and thus deterioration in the image quality is not caused. Even when the preference transmission method is the second transmission method, the super-resolution technique is applied to the reduced video V1 in the receiving-side device 20, and thus the image quality is improved. It is therefore possible to satisfy both the high image quality and the low delay. For example, satisfying both the high image quality and the low delay contributes to an improvement in the remote support accuracy.

### 4. MODIFICATION EXAMPLE

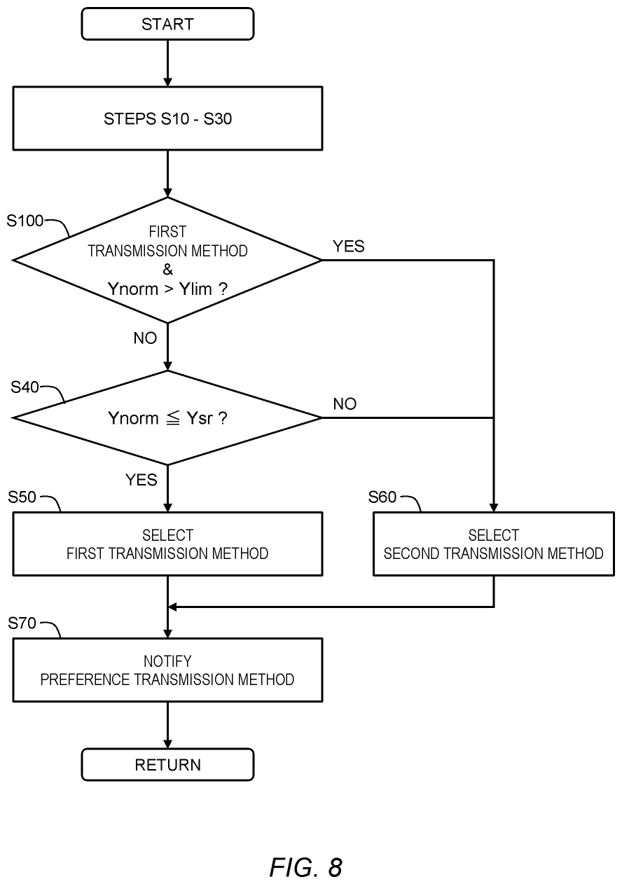

FIG. 8 is a flow chart showing a modification example. The description overlapping with the flow chart shown in FIG. 7 will be omitted as appropriate. Steps S10 to S30 are the same as those described above.

In Step S100, the receiving-side device 20 (the transmission method selection unit 25) determines whether or not the current preference transmission method is the first transmission method and the first delay time Ynorm exceeds a predetermined delay limit Ylim. When the current preference transmission method is the first transmission method and the first delay time Ynorm exceeds the predetermined delay limit Ylim (Step S100; Yes), the receiving-side device 20 selects the second transmission method as the preference transmission method (Step S60). In other words, the receiving-side device 20 forcibly switches the preference transmission method from the first transmission method to the second transmission method. Otherwise (Step S100; No), Steps S40 to S70 are performed in the same manner as described above.

According to the modification example, robustness of the video transmission is improved.

### 5. CONFIGURATION EXAMPLE OF REMOTE SUPPORT SYSTEM

Hereinafter, a concrete configuration example of the remote support system 1A shown in FIG. 2 will be described. The remote support system 1A includes the moving body 100 and the remote support device 200. The moving body 100 and the remote support device 200 are able to communicate with each other. The remote support device 200 remotely supports an operation of the moving body 100 based on the video transmitted from the moving body 100.

### 5-1. Moving Body

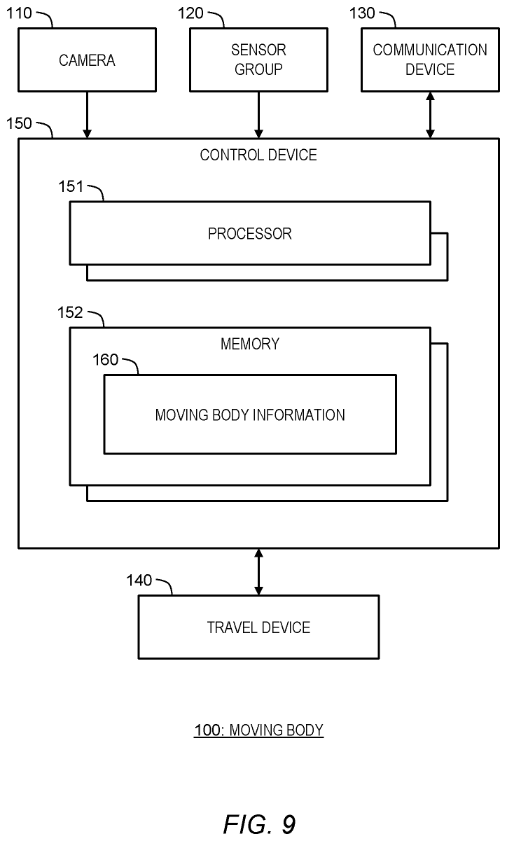

FIG. 9 is a block diagram showing a configuration example of the moving body 100. The moving body 100 includes a camera 110, a sensor group 120, a communication device 130, a travel device 140, and a control device 150. In the present example, the moving body 100 is one having wheels, such as a vehicle and a robot.

The camera 110 images a situation around the moving body 100 to acquire the image indicating the situation around the moving body 100. The image is typically a video (moving image), but may be a static image.

The sensor group 120 includes a state sensor that detects a state of the moving body 100. The state sensor includes a speed sensor, an acceleration sensor, a yaw rate sensor, a steering angle sensor, and the like. The sensor group 120 also includes a position sensor that detects a position and an orientation of the moving body 100. The position sensor is exemplified by a GPS (Global Positioning System) sensor. Moreover, the sensor group 120 may include a recognition sensor other than the camera 110. The recognition sensor recognizes (detects) the situation around the moving body 100. Examples of the recognition sensor include a LIDAR (Laser Imaging Detection and Ranging), a radar, and the like.

The communication device 130 communicates with the outside of the moving body 100. For example, the communication device 130 communicates with the remote support device 200.

The travel device 140 includes a steering device, a driving device, and a braking device. The steering device turns wheels of the moving body 100. For example, the steering device includes an electric power steering (EPS) device. The driving device is a power source that generates a driving force. Examples of the drive device include an engine, an electric motor, an in-wheel motor, and the like. The braking device generates a braking force.

The control device (controller) 150 controls the moving body 100. The control device 150 includes one or more processors 151 (hereinafter simply referred to as a processor 151) and one or more memories 152 (hereinafter simply referred to as a memory 152). The processor 151 executes a variety of processing. For example, the processor 151 includes a CPU (Central Processing Unit). The memory 152 stores a variety of information. Examples of the memory 152 include a volatile memory, a non-volatile memory, an HDD (Hard Disk Drive), an SSD (Solid State Drive), and the like. The variety of processing by the processor 151 (the control device 150) is implemented by the processor 151 executing a control program being a computer program. The control program is stored in the memory 152 or recorded on a non-transitory computer-readable recording medium. The control device 150 may include one or more ECUs (Electronic Control Units).

The processor 151 acquires moving body information 160 by using the camera 110 and the sensor group 120. The moving body information 160 includes the video (i.e., the original video V0) captured by the camera 110. Moreover, the moving body information 160 includes state information indicating the state of the moving body 100 detected by the state sensor. Furthermore, the moving body information 160 includes position information indicating the position and the orientation of the moving body 100 detected by the position sensor. Furthermore, the moving body information 160 includes object information regarding an object recognized (detected) by the recognition sensor. The object information indicates a relative position and a relative velocity of the object with respect to the moving body 100.

Moreover, the processor 151 controls travel of the moving body 100. The travel control includes steering control, acceleration control, and deceleration control. The processor 151 executes the travel control by controlling the travel device 140. The processor 151 may perform automated driving control. When performing the automated driving control, the processor 151 generates a target trajectory of the moving body 100 based on the moving body information 160. The target trajectory includes a target position and a target velocity. Then, the processor 151 executes the travel control such that the moving body 100 follows the target trajectory.

Furthermore, the processor 151 communicates with the remote support device 200 via the communication device 130. For example, the processor 151 transmits at least a part of the moving body information 160 to the remote support device 200, as necessary.

In particular, when the remote support is necessary, the processor 151 transmits the video (i.e., the original video V0 or the reduced video V1) to the remote support device 200. Here, if necessary, the processor 151 executes the above-described congestion control to generate the reduced video V1 from the original video V0 and then transmits the reduced video V1. In addition, the processor 151 receives the preference transmission method information MS from the remote support device 200. The processor 151 performs the transmission process in accordance with the preference transmission method specified by the preference transmission method information MS.

It should be noted that in the case where the remote support is requested, the processor 151 receives the operator instruction from the remote support device 200. When receiving the operator instruction, the processor 151 executes the travel control in accordance with the operator instruction

The control device 150 (the processor 151 and the memory 152) and the communication device 130 described above correspond to the “transmitting-side device 10” according to the present embodiment.

### 5-2. Remote Support Device

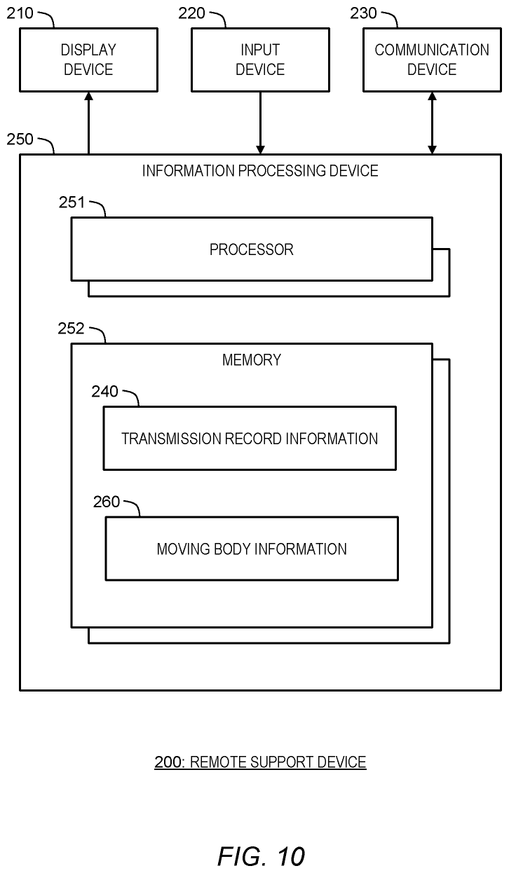

FIG. 10 is a block diagram showing a configuration example of the remote support device 200 according to the present embodiment. The remote support device 200 includes a display device 210, an input device 220, a communication device 230, and an information processing device 250.

The display device 210 displays a variety of information. Examples of the display device 210 include a liquid crystal display, an organic EL display, a head-mounted display, a touch panel, and the like.

The input device 220 is an interface for accepting input from the operator. Examples of the input device 220 include a touch panel, a keyboard, a mouse, and the like. In a case where the remote support is the remote driving, the input device 220 includes a driving operation member used by the operator for performing a driving operation (steering, acceleration, and deceleration).

The communication device 230 communicates with the outside. For example, the communication device 230 communicates with the moving body 100.

The information processing device 250 executes a variety of information processing. The information processing device 250 includes one or more processors 251 (hereinafter simply referred to as a processor 251) and one or more memories 252 (hereinafter simply referred to as a memory 252). The processor 251 executes a variety of processing. For example, the processor 251 includes a CPU. The memory 252 stores a variety of information. Examples of the memory 252 include a volatile memory, a non-volatile memory, an HDD, an SSD, and the like. The functions of the information processing device 250 are implemented by the processor 251 executing a remote support program being a computer program. The remote support program is stored in the memory 252. The remote support program may be recorded on a non-transitory computer-readable recording medium. The remote support program may be provided via a network.

The processor 251 executes the remote support process that remotely supports the operation of the moving body 100. The remote support processing includes an “information providing process” and an “operator instruction notification process.”

The information providing process is as follows. The processor 251 receives moving body information 260 necessary for the remote support from the moving body 100 via the communication device 230. The moving body information 260 includes at least a part of the above-described moving body information 160. In particular, the moving body information 260 includes the video (i.e., the original video V0 or the reduced video V1) transmitted from the moving body 100. If necessary, the processor 251 executes the above-described super-resolution process to generate the improved video V2 from the reduced video V1. In that case, the moving body information 260 includes the improved video V2. The moving body information 260 is stored in memory 252. The processor 251 presents the moving body information 260 to the operator by displaying the moving body information 260 on the display device 210.

The operator looks at the video displayed on the display device 210 to grasp the situation around the moving body 100. The operator remotely supports the operation of the moving body 100. Examples of the remote support by the operator include recognition support, judgement support, remote driving, and the like. The operator uses the input device 220 to input the operator instruction.

The operator instruction notification process is as follows. The processor 251 receives the operator instruction input by the operator from the input device 220. Then, the processor 251 transmits the operator instruction to the moving body 100 via the communication device 230.

In addition, the processor 251 executes the selection process that selects the preference transmission method according to a situation. More specifically, the processor 251 generates and accumulates the transmission record information 240 based on information included in the received video VR. The transmission record information 240 is stored in the memory 252. The processor 251 calculates (estimates) the first delay time Ynorm and the second delay time Ysr based on the transmission record information 240. Then, the processor 251 compares the first delay time Ynorm and the second delay time Ysr to select the preference transmission method.

Furthermore, the processor 251 generates the preference transmission method information MS specifying the preference transmission method. Then, the processor 251 transmits the preference transmission method information MS to the moving body 100 via the communication device 230.

The information processing device 250 (the processor 251 and the memory 252) and the communication device 230 described above correspond to the “receiving-side device 20” according to the present embodiment.

What is claimed is:

1. A video communication method of transmitting a video from a transmitting-side device to a receiving-side device,
the video communication method comprising:
a transmission process that transmits the video by a preference transmission method that is any of a first transmission method and a second transmission method, wherein the first transmission method transmits an original video as the video, and the second transmission method generates a reduced video by reducing the original video and transmits the reduced video as the video;
a reception process that receives the video transmitted; and
a super-resolution process that, when the reduced video transmitted by the second transmission method is received, applies a super-resolution technique to the reduced video to generate an improved video, wherein
a transmission time is a time required for transmission of the video from the transmitting-side device to the receiving-side device,
a first delay time is the transmission time in a case of the first transmission method,
a second delay time is a sum of the transmission time in a case of the second transmission method and a super-resolution processing time required for generating the improved video by the super-resolution technique, and
the video communication method further comprises: a selection process that compares the first delay time and the second delay time to select a transmission method corresponding to a shorter one of the first delay time and the second delay time as the preference transmission method.

2. The video communication method according to claim 1, wherein
the selection process includes:
calculating the transmission time based on information included in the video received; and
estimating both the first delay time and the second delay time based on the transmission time.

3. The video communication method according to claim 2, wherein
the transmission time in the case of the first transmission method is a sum of a fixed delay and a first variable delay,
the transmission time in the case of the second transmission method is a sum of the fixed delay and a second variable delay,
the first variable delay depends on a data amount of the original video and a bit rate of a communication line between the transmitting-side device and the receiving-side device,
the second variable delay depends on a data amount of the reduced video and the bit rate, and
the selection process includes:
estimating the bit rate and the fixed delay based on a correspondence relationship between the data amount and the transmission time in a certain period of time; and
calculating both the first delay time and the second delay time based on the bit rate, the fixed delay, and the super-resolution processing time.

4. The video communication method according to claim 1, further comprising: when the preference transmission method is the first transmission method and the first delay time exceeds a predetermined delay limit, switching the preference transmission method from the first transmission method to the second transmission method.

5. A video communication system comprising:
a transmitting-side device configured to transmit a video by a preference transmission method that is any of a first transmission method and a second transmission method; and
a receiving-side device configured to receive the video transmitted from the transmitting-side device, wherein
the first transmission method transmits an original video as the video,
the second transmission method generates a reduced video by reducing the original video and transmits the reduced video as the video,
the receiving-side device is further configured to, when receiving the reduced video transmitted by the second transmission method, apply a super-resolution technique to the reduced video to generate an improved video,
a transmission time is a time required for transmission of the video from the transmitting-side device to the receiving-side device,
a first delay time is the transmission time in a case of the first transmission method,
a second delay time is a sum of the transmission time in a case of the second transmission method and a super-resolution processing time required for generating the improved video by the super-resolution technique, and
the receiving-side device is further configured to:
compare the first delay time and the second delay time to select a transmission method corresponding to a shorter one of the first delay time and the second delay time as the preference transmission method; and
notify the transmitting-side device of the preference transmission method.

6. The video communication system according to claim 5, wherein
the receiving-side device is further configured to:
calculate the transmission time based on information included in the video received; and
estimate both the first delay time and the second delay time based on the transmission time.

7. The video communication system according to claim 6, wherein
the transmission time in the case of the first transmission method is a sum of a fixed delay and a first variable delay,
the transmission time in the case of the second transmission method is a sum of the fixed delay and a second variable delay,
the first variable delay depends on a data amount of the original video and a bit rate of a communication line between the transmitting-side device and the receiving-side device,
the second variable delay depends on a data amount of the reduced video and the bit rate, and
the receiving-side device is further configured to:
estimate the bit rate and the fixed delay based on a correspondence relationship between the data amount and the transmission time in a certain period of time; and
calculate both the first delay time and the second delay time based on the bit rate, the fixed delay, and the super-resolution processing time.

8. The video communication system according to claim 5, wherein
when the preference transmission method is the first transmission method and the first delay time exceeds a predetermined delay limit, the receiving-side device is further configured to switch the preference transmission method from the first transmission method to the second transmission method.

9. The video communication system according to claim 5, wherein
the transmitting-side device is installed on a moving body,
the original video is acquired by a camera installed on the moving body, and
the receiving-side device is included in a remote support device that remotely supports an operation of the moving body based on the video.

10. A receiving-side device that receives a video transmitted from a transmitting-side device, wherein the transmitting-side device transmits the video by a preference transmission method that is any of a first transmission method and a second transmission method, the first transmission method transmits an original video as the video, and the second transmission method generates a reduced video by reducing the original video and transmits the reduced video as the video,
the receiving-side device comprising one or more processors configured to:
receive the video transmitted from the transmitting-side device; and
when receiving the reduced video transmitted by the second transmission method, apply a super-resolution technique to the reduced video to generate an improved video, wherein
a transmission time is a time required for transmission of the video from the transmitting-side device to the receiving-side device,
a first delay time is the transmission time in a case of the first transmission method,
a second delay time is a sum of the transmission time in a case of the second transmission method and a super-resolution processing time required for generating the improved video by the super-resolution technique, and
the one or more processors are further configured to:
compare the first delay time and the second delay time to select a transmission method corresponding to a shorter one of the first delay time and the second delay time as the preference transmission method; and
notify the transmitting-side device of the preference transmission method.
